(19) United States
(12) Patent Application Publication
(10) Pub. No.: US 2023/0159728 A1
(43) Pub. Date: May 25, 2023

(54) RUBBER COMPOSITION, AND PNEUMATIC TIRE USING THE SAME

(71) Applicant: Toyo Tire Corporation, Itami-shi (JP)

(72) Inventor: Hironori Miyazaki, Itami-shi (JP)

(73) Assignee: Toyo Tire Corporation, Itami-shi (JP)

(21) Appl. No.: 17/978,611

(22) Filed: Nov. 1, 2022

(30) Foreign Application Priority Data
Nov. 17, 2021 (JP) 2021-187380

(51) Int. Cl. C08K 5/38; C08K 3/06; B60C 1/00

(52) U.S. Cl. CPC C08K 5/38; B60C 1/00; C08K 3/06

(57) ABSTRACT

To provide a rubber composition excellent in fracture characteristics while maintaining hardness, and to provide a pneumatic tire using the same. The rubber composition contains a diene-based rubber, and 0.1 to 10 parts by mass of a thioester-based compound represented by the general formula (1) (each A is an alkyl group or aromatic having 1 to 10 carbon atoms, and may be the same or different, and n is an integer of 1 to 6) with respect to 100 parts by mass of the diene-based rubber.

A—COS— (CH₂) ₙ—SCO—A

### BACKGROUND OF THE INVENTION

### 1. Field of the Invention

The present invention relates to a rubber composition and a pneumatic tire using the rubber composition.

### 2. Description of the Related Art

In recent years, rubber products such as tires have been required to have further improved fracture characteristics in order to improve durability. In order to solve such a problem, use of a plurality of crosslinking agents has been studied.

For example, JP-A-2005-263892 (Patent Literature -L) describes that reversion and heat aging characteristics can be improved by using 1, 6-bis (N, N-dibenzylthiocarbamoyldithio)hexane as a crosslinking agent in addition to sulfur.

In addition, JP-A-2014-118419 (Patent Literature 2) describes that toughness can be improved by using 1,8-bis(thiobenzoate)octane as a crosslinking agent in addition to sulfur.

### SUMMARY OF THE INVENTION

However, with respect to the 1,6-bis(N,N-dibenzylthiocarbamoyldithio) hexane disclosed in Patent Literature 1, there is room for improvement in fracture characteristics, and with respect to the 1,8-bis (thiobenzoate)octane disclosed in Patent Literature 2, there has been a problem in that hardness is reduced.

In view of the above, an object of the present invention is to provide a rubber composition capable of improving fracture characteristics while maintaining hardness, and a pneumatic tire using the same.

Japanese Patent No. 5647619 (Patent Literature 3) describes that a blocked mercaptosilane coupling agent is used in a rubber composition for a tire, but does not describe fracture characteristics.

The rubber composition according to the present invention contains a diene-based rubber, and a thioester-based compound represented by the following general formula (1) in an amount of 0.1 to 10 parts by mass with respect to 100 parts by mass of the diene-based rubber:

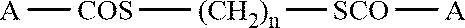

wherein each A is an alkyl group or aromatic having 1 to 10 carbon atoms, and may be the same or different, and n is an integer of 1 to 6.

The thioester-based compound may be a compound represented by the formula (1) in which n - 6.

The rubber composition may contain sulfur in an amount of 0.1 to 10 parts by mass with respect to 100 parts by mass of the diene-based rubber.

A pneumatic tire according to the present: invention is produced by using the above-described rubber composition.

According to the rubber composition of the present invention, excellent fracture characteristics can be obtained While maintaining hardness.

### DESCRIPTION OF EMBODIMENTS

Hereinafter, matters related to the implementation of the present invention will be described in detail.

The rubber composition according to the present embodiment contains a diene-based rubber, and a thioester-based compound represented by the following general formula (1) in an amount of 0.1 to 10 parts by mass with respect to 100 parts by mass of the diene-based rubber.

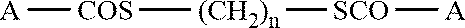

In the formula (1), each A is an alkyl group or aromatic having 1 to 10 carbon atoms, and may be the same or different, and n is an integer of 1 to 6, preferably an integer of 3 to 6, and more preferably 6.

The rubber composition according to the present embodiment contains a diene-based rubber as a rubber component, and the type thereof is not particularly limited, but examples thereof include natural rubber (NR), isoprene rubber (IR), butadiene rubber (BR), styrene-butadiene rubber (SBR), styrene-isoprene copolymer rubber, butadiene-isoprene copolymer rubber, styrene-isoprene-butadiene copolymer rubber, acrylonitrile butadiene rubber (NBR), chloroprene rubber (CR) , and butyl rubber (IIR).

The thioester-based compound according to the present embodiment is not particularly limited as long as it is represented by the above general formula (1). A in the general formula (1) is not particularly limited as long as it is an alkyl group or aromatic having 1 to 10 carbon atoms, and a thioester group is decomposed and liberated as a carboxylic acid during a crosslinking reaction, and thus does not affect a crosslinked structure. A in the general formula (1) may be, for example, a linear alkyl group such as a methyl group, an ethyl group, a n-propyl group, a n-butyl group, a n-pentyl group, a n-hexyl group, a n-heptyl group, a n-octyl group, a n-nonyl group, and a n-decyl group; a branched alkyl group such as an isopropyl group, an isobutyl group, a t-butyl group, an isopentyl group, a neopentyl group, an isohexyl group, an isoheptyl group, an isooctyl group, a 2-ethylhexyl group, an isononyl group, and an isodecyl group; an alicyclic alkyl group such as a cyclopropyl group, a cyclopentyl group, a cyclohexyl group, a cycloheptyl group, a cyclooctyl group, and a tricyclodecyl group; and an aromatic hydrocarbon group such as a phenyl group, a phenethyl group, and a benzyl group.

The content of the thioester-based compound is 0.1 to 10 parts by mass, preferably 0.1 to 5 parts by mass, and more preferably 0.1 to 3 parts by mass with respect to 100 parts by mass of the diene-based rubber. When the content of the thioester-based compound is within the above-mentioned range, excellent hardness and fracture characteristics are easily obtained.

By using the thioester-based compound, it is possible to improve fracture characteristics while maintaining hardness. This mechanism is not clear, but can be presumed as follows. That is, it is considered that the fracture characteristics are improved by introducing a crosslinking chain which is moderately longer than the sulfur crosslinking commonly used in rubber products, and improving the flexibility of rubber while suppressing the decrease in hardness. In addition, wet grip performance is also improved due to the improved flexibility of the rubber.

The rubber composition according to the present embodiment may contain sulfur, and the content thereof is preferably 0.1 to 10 parts by mass, and more preferably 1 to 5 parts by mass with respect to 100 parts by mass of the diene-based rubber. Examples of the sulfur include sulfur components such as powdered sulfur, precipitated sulfur, colloidal sulfur, insoluble sulfur, and highly dispersible sulfur.

The rubber composition according to the present embodiment may further contain a vulcanization accelerator, and the content thereof is preferably 0.1 to 3 parts by mass, and more preferably 0.2 to 3 parts by mass with respect to 100 parts by mass of the diene-based rubber. Examples of the vulcanization accelerator include sulfenamide type vulcanization accelerators, thiuram type vulcanization accelerators, thiazole type vulcanization accelerators, thiourea type vulcanization accelerators, guanidine type vulcanization accelerators, and dithiocarbamate type vulcanization accelerators.

In the rubber composition according to the present embodiment, in addition to the above-described components, compounding chemicals such as reinforcing filler, process oil, softening agent, plasticizer, wax, and aging inhibitor, which are used in the ordinary rubber industry, can be appropriately blended within a normal range.

As the reinforcing filler, it is preferable to use carbon black and/or silica. That is, the reinforcing filler may be carbon black alone, silica alone, or a combination of carbon black and silica. Preferably, carbon black alone or a combination of carbon black, and silica is used. The content of the reinforcing filler is not particularly limited, and is, for example, preferably 10 to 140 parts by mass, more preferably 20 to 100 parts by mass, and still more preferably 30 to 80 parts by mass with respect to 100 parts by mass of the diene-based rubber.

The carbon black is not particularly limited, and various known types can be used. The content of the carbon black is preferably 5 to 100 parts by mass, and more preferably 20 to 80 parts by mass with respect to 100 parts by mass of the diene-based rubber.

The silica is also not particularly limited, but wet silica such as wet precipitated silica and wet gel method silica is preferably used. When silica is blended, the content thereof is preferably 5 to 40 parts by mass, and more preferably 5 to 30 parts by mass with respect to 100 parts by mass of the diene-based rubber.

The rubber composition according to the present embodiment can be produced by kneading in accordance with an ordinary method using a mixer such as a Banbury mixer, a kneader, or a roll that is usually used. That is, for example, the rubber composition can be prepared by adding and mixing other additives except for the thioester-based compound, the vulcanizing agent, and the vulcanization accelerator to the diene-based rubber in a first mixing stage, and then adding and mixing the thioester-based compound, the vulcanizing agent, and the vulcanization accelerator to the obtained mixture in a final mixing stage.

The rubber composition thus obtained can be applied to various parts of tires such as treads and sidewalls of pneumatic tires of various applications and various sizes such as tires for passenger cars and large tires for trucks and buses. That is, the rubber composition is molded into a predetermined shape by an ordinary method, for example, extrusion processing, combined with other components to produce a green tire, and then the green tire is vulcanization-molded at, for example, 140° C. to 180° C., whereby a pneumatic tire can be produced. Among these, it is particularly preferable to use the rubber composition as a formulation for treads of tires.

### EXAMPLES

Examples of the present invention will be described below, but the present invention is not limited to these examples.

### Synthesis Example 1

Under a nitrogen atmosphere, 40 mL of acetonitrile, 2.4 g (20 mmol) of benzoic acid, 9.2 g (48 mmol) of p-toluenesulfonic acid chloride, and 9.8 g (120 mmol) of N-methylimidazole were added, and the mixture was stirred at room temperature for 1 hour. In another container, 1.5 g (10 mmol) of 1,6-hexanedithiol was dissolved in 20 mL of acetonitrile. This solution was added and stirred at room temperature for an additional 3 hours. After completion of the reaction, water was added to the reaction solution, and the mixture was extracted three times with dichloromethane. The obtained organic layer was washed with saturated brine, dehydrated with anhydrous magnesium sulfate, filtered, and concentrated under reduced pressure. The concentrate thus obtained was purified by silica gel column chromatography to obtain 3.4 g of 1,6-bis(thiobenzoate)hexane (yield 94%).

### Synthesis Example 2

Under a nitrogen atmosphere, 17 mL of dichloromethane, 1.5 g (10 mmol) of 1,6-hexanedithiol, 6.0 g (60 mmol) of isopropenyl acetate, and 150 mg (1 mmol) of trifluoromethanesulfonic acid were added, and the mixture was stirred at room temperature for 1 hour. After completion of the reaction, potassium carbonate was added and the mixture was stirred for 30 minutes. The mixture was then diluted with ethyl acetate, filtered through celite, and concentrated under reduced pressure. The concentrate thus obtained was purified by silica gel column chromatography to obtain 2.2 g of 1,6-bis(thioacetate)hexane (yield 95%).

### Synthesis Example 3

Under a nitrogen atmosphere, 40 mL of acetonitrile, 2.4 g (20 mmo1) of benzoic acid, 9.2 g (48 mmo1) of p-toluenesulfonic acid chloride, and 9.8 g (120 mmo1) of N-methylimidazole were added, and the mixture was stirred at room temperature for 1 hour. In another container, 1.8 g (10 mmo1) of 1,8-octanedithiol was dissolved in 20 mL of acetonitrile. This solution was added and stirred at room temperature for an additional 3 hours. After completion of the reaction, water was added to the reaction solution, and the mixture was extracted three times with dichloromethane. The obtained organic layer was washed with saturated brine, dehydrated with anhydrous magnesium sulfate, filtered, and concentrated under reduced pressure. The concentrate thus obtained was purified by silica gel column chromatography to obtain 3.8 g of 1,8-bis(thiobenzoate)octy1 (yield 99%).

A rubber composition was prepared using a Banbury mixer according to the mix proportion (parts by mass) shown in Table 1 below by first adding and mixing the components except for sulfur, a vulcanization accelerator, and a thioester-based compound in a first mixing stage (discharge temperature = 160° C.), and then adding and mixing the sulfur, the vulcanization accelerator, and the thioester-based compound to the resulting mixture in a second mixing stage (discharge temperature = 90° C.) .

The details of each component in Table 1 are as follows.
Isoprene rubber: “IR2200” manufactured by JSR Corporation
Carbon black: “SHOWBLACK N330T” manufactured by Cabot Japan K.K.
Zinc oxide; “Zinc Oxide Type III” manufactured by Mitsui Mining & Smelting Co., Ltd.
Stearic acid: “Lunac S-20” manufactured by Kao Corporation
Sulfur: “Powdered sulfur” manufactured by Tsurumi Chemical Industry Co., Ltd.
Thioester-based compound 1: 1,6-bis(thiobenzoate)hexane obtained in Synthesis Example 1
Thioester-based compound 2: 1,6-bis(thioacetate)hexane obtained in Synthesis Example 2
Thioester-based compound 3: 1,8-bis(thiobenzoate)octyl obtained in Synthesis Example 3
Vulcanization accelerator: “Nocceler CZ-G” manufactured by Ouchi Shinko Chemical Industrial Co., Ltd.

Each of the obtained rubber compositions was vulcanized under pressure at 160° C. using a metallic plate as a mold to prepare a vulcanized rubber sample. As the vulcanization time, 90% vulcanization time described in JIS K6300-2 was applied.

Hardness: The hardness at a temperature of 23° C. was measured by a type A durometer in accordance with JIS K6253, and expressed as an index with the value of Comparative Example 1 being 100. A larger index indicates a higher hardness at room temperature.

Tensile strength at break: The tensile strength at break was measured by a tensile test (dumbbell shape No. 7) in accordance with JIS K6251, and expressed as an index with the value of Comparative Example 1. being 100. A larger index indicates better fracture characteristics.

Elongation at break: A tensile test (dumbbell shape No. 7) was performed in accordance with JIS K6251 to measure the elongation at break, and the elongation at break was expressed as an index with the value of Comparative Example 1 being 100. A larger index indicates better fracture characteristics.

Wet grip performance: The loss factor tan δ was measured using a rheospectrometer E4000 manufactured by UBM under the conditions of frequency 10 Hz, 10% static strain, 2% dynamic strain, and temperature 0° C., and expressed as an index with the value of Comparative Example 1 being 100. A larger index indicates that the tan δ is larger and the wet grip performance is better.

TABLE 1

| | Comparative Example 1 | Example 1 | Example 2 | Example 3 | Comparative Example 2 | Comparative Example 3 |
|---|---|---|---|---|---|---|
| isoprene rubber | 100 | 100 | 100 | 100 | 100 | 100 |
| Carbon black | 30 | 30 | 30 | 30 | 30 | 30 |
| Zinc oxide | 2 | 2 | 2 | 2 | 2 | 2 |
| Stearic acid | 1 | 1 | 1 | 1 | 1 | 1 |
| Sulfur | 2.5 | 1.5 | 2 | 2 | 1.5 | 2 |
| Thioester-based compound 1 | - | 1 | 0.5 | - | - | - |
| Thioester-based compound 2 | - | - | - | 0.5 | - | - |
| Thioester-based compound 3 | - | - | - | - | 1 | 0.5 |
| Vulcanization accelerator | 1 | 1 | 1 | 1 | 1 | 1 |
| Hardness | 100 | 100 | 102 | 100 | 91 | 95 |
| Tensile strength at break | 100 | 103 | 112 | 114 | 114 | 122 |
| Elongation at break | 100 | 107 | 105 | 109 | 105 | 105 |
| Wet grip performance | 100 | 103 | 104 | 101 | 102 | 102 |

The results are shown in Table 1, and Comparative Examples 2 and 3 were examples in which 1,8-bis(thiobenzoate)octyl was used as the thioester-based compound, and the hardness was inferior to that of Comparative Example 1.

On the other hand, Example 1 is an example in which a thioester-based compound having a shorter carbon chain between thioesters than the thioester-based compounds used in Comparative Examples 2 and 3 was used, and as compared with Comparative Example 1, fracture characteristics and wet grip performance were improved while maintaining or improving hardness.

The rubber composition of the present invention can be used for a tread, a side wall, a belt, a carcass and the like of a tire for a passenger car or a large tire for a truck or a bus.

What is claimed is:

1. A rubber composition comprising: a diene-based rubber; and a thioester-based compound represented by the following general formula (1) in an amount of 0.1 to 10 parts by mass with respect to 100 parts by mass of the diene-based rubber: 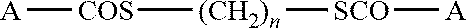
wherein each A is an alkyl group or aromatic having 1 to 10 carbon atoms, and may be the same or different, and n is an integer of 1 to 6.

2. The rubber composition according to claim 1, wherein the thioester-based compound is a compound represented by the formula (1) in which n = 6.

3. The rubber composition according to claim 1, further comprising 0.1 to 10 parts by mass of sulfur with respect to 100 parts by mass of the diene-based rubber.

4. The rubber composition according to claim 2, further comprising 0.1 to 10 parts by mass of sulfur with respect to 100 parts by mass of the diene-based rubber.

5. A pneumatic tire produced by using the rubber composition according to claim 1.

6. A pneumatic tire produced by using the rubber composition according to claim 2.

7. A pneumatic tire produced by using the rubber composition according to claim 3.

8. A pneumatic tire produced by using the rubber composition according to claim 4.
